(19) United States
(12) Patent Application Publication
(10) Pub. No.: US 2025/0038878 A1
(43) Pub. Date: Jan. 30, 2025

(54) SPATIAL MODULATION-BASED ORTHOGONAL SIGNAL DIVISION MULTIPLEXING COMMUNICATIONS

(71) Applicant: Rutgers, The State University of New Jersey, New Brunswick, NJ (US)

(72) Inventors: Dario Pompili, New Brunswick, NJ (US); Zhuoran Qi, New Brunswick, NJ (US)

(73) Assignee: Rutgers, The State University of New Jersey, New Brunswick, NJ (US)

(21) Appl. No.: 18/782,246

(22) Filed: Jul. 24, 2024

Related U.S. Application Data
(60) Provisional application No. 63/528,452, filed on Jul. 24, 2023.

(51) Int. Cl. H04J 14/00; H04B 10/80

(52) U.S. Cl. CPC H04J 14/05; H04B 10/80

(57) ABSTRACT

Various embodiments comprise systems, methods, architectures, mechanisms and apparatus for optical, radio frequency (RF), and/or acoustic data transmission by dividing each of one or more sequences of channel coded bits d into N blocks thereof, which are respectively spatially modulated (SM) with respective pilot sequences and mapped to constellations to provide thereby respective symbol streams, which are modulated in accordance with orthogonal signal division multiplexing (OSDM) to provide respective SM-OSDM signals, which are transmitted via optical sources, RF antennae, acoustic transducers, and the like during respective timeslots such that a receiver associated with a plurality of receiving devices may reconstruct the bitstream used to form the one or more sequences of channel coded bits d.

### CROSS REFERENCE TO RELATED APPLICATION

This application claims the benefit of the filing date of U.S. Provisional Patent Application No. 63/528,452 filed Jul. 24, 2023, the disclosure of which is incorporated herein by reference in its entirety.

### GOVERNMENT INTEREST

This invention was made with government support under NSF NeTS Award No. CNS-1763964. The government has certain rights in the invention.

### FIELD OF THE DISCLOSURE

The present disclosure generally relates to communications and, in particular, to Spatial Modulation (SM) Orthogonal Signal Division Multiplexing (OSDM) communications systems.

### BACKGROUND

Wireless communication has played an important role in the military, commercial, and scientific fields. With the increasing demand for reliable underwater/undersea wireless communication systems, three main-stream communications mechanisms are typically considered: Underwater Radio Frequency Communication (URFC), Underwater Acoustic Communication (UAC), and Underwater Wireless Optical Communication (UWOC).

URFC provides high bandwidth and data rate, but radio waves suffer high attenuation in seawater due to the high conductivity and permittivity, leading to a limited coverage distance of up to a few meters. UWOC offers a wider bandwidth on the scale of hundreds of megahertz. However, the UWOC suffers from water absorption and scattering effects and attenuates greatly. Additionally, some alignments between the transmitter and the receiver are required, and the quality of the communication link can be severely impaired by external factors, such as the presence of sources of reflection, e.g., bubbles.

Different from URFC and UWOC, UAC suffers less attenuation and covers a communication range of up to kilometers, but the underwater acoustic speed is as slow as 1500 m/s, leading to time-varying multipath delay. Moreover, the Doppler effects caused by the dynamic water wave, low bandwidth, sound speed variability, and frequency-dependent scattering losses still make UAC a challenge.

Improvements are desired.

### SUMMARY

Various deficiencies in the prior art are addressed by systems, methods, architectures, mechanisms, and apparatus for optical, radio frequency (RF), and/or acoustic data transmission by dividing each of one or more sequences of channel coded bits d into N blocks thereof, which are respectively spatially modulated (SM) with respective pilot sequences and mapped to constellations to provide thereby respective symbol streams, which are modulated in accordance with orthogonal signal division multiplexing (OSDM) to provide respective SM-OSDM signals, which are transmitted via optical sources, RF antennae, acoustic transducers, and the like during respective timeslots such that a receiver associated with a plurality of receiving devices may reconstruct the bitstream used to form the one or more sequences of channel coded bits d.

A method of communication according to an embodiment comprises: channel coding and interleaving input data to provide one or more sequences of channel coded bits d; spatially modulating (SM) and mapping to a constellation each sequence of channel coded bits d to provide a respective plurality of symbol streams; modulating each symbol stream and its respective pilot sequence in accordance with orthogonal signal division multiplexing (OSDM) to provide a respective SM-OSDM signal; and transmitting each SM-OSDM signal via a respective transmitting device during a respective time slot. The method may further comprise: receiving, via each of a second plurality of receiving devices, some or all of the transmitted SM-OSDM signals; channel equalizing and OSDM demodulating received SM-OSDM signals to provide a plurality of channel equalized received signals; spatial demodulating and constellation de-mapping the channel equalized received signals to retrieve therefrom a bitstream comprising the sequence of channel coded bits d; and de-interleaving and channel decoding the retrieved bitstream to obtain therefrom an output bit sequence.

A communications system according to an embodiment comprises a spatial modulation (SM) orthogonal signal division multiplexing (OSDM) transmitter configured for generating a plurality of SM-OSDM signals for transmission, the SM-OSDM transmitter comprising: a channel coding and interleaving module for channel coding and interleaving input data to provide one or more sequences of channel coded bits d; a spatial modulator (SM) and mapping module, for spatially modulating (SM) and mapping to a constellation each sequence of channel coded bits d to provide a respective plurality of symbol streams; and an OSDM modulator, for modulating each symbol stream and its respective pilot sequence in accordance with orthogonal signal division multiplexing (OSDM) to provide respective SM-OSDM signals suitable for transmission via respective transmitting devices during respective time slots; and a SM-OSDM receiver configured for receiving a plurality of SM-OSDM signals and obtaining therefrom the input bit sequence, the SM-OSDM receiver comprising: a channel equalizing and OSDM demodulating module for processing received SM-OSDM signals to provide a plurality of channel equalized received signals; a spatial demodulating and constellation de-mapping module for spatial demodulating and constellation de-mapping the channel equalized received signals to retrieve therefrom a bitstream comprising the sequence of channel coded bits d; and a de-interleaving and channel decoding module, for de-interleaving and channel decoding the received bitstream to obtain therefrom an output bit sequence.

Additional objects, advantages, and novel features of the invention will be set forth in part in the description which follows and will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, explain the principles of the present invention.

FIG. 1 depicts a high-level block diagram of a communications system according to various embodiments;

FIG. 2 graphically depicts an illustrative spatial modulation structure suitable for use with the communications system 100 of FIG. 1;

FIG. 3 depicts a high-level block diagram of a controller suitable for use in various embodiments, such as to implement a transmitter, receiver, transceiver, system or component thereof in accordance with the various embodiments;

FIG. 4 depicts a flow diagram of a method according to an embodiment;

FIG. 5A-5C graphically illustrate Bit Error Rate (BER) as a function of normalized SNR (Eb/No) for different modulation schemes and different water wave speeds; and

FIG. 6A-6C graphically illustrate spectral efficiency as a function of Eb/No for different modulation schemes and different water wave speeds;

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION

The following description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for pedagogical purposes to aid the reader in understanding the principles of the invention and the concepts contributed by the inventor(s) to furthering the art and are to be construed as being without limitation to such specifically recited examples and conditions. Additionally, the term, “or” as used herein, refers to a non-exclusive or, unless otherwise indicated (e.g., “or else” or “or in the alternative”). Also, the various embodiments described herein are not necessarily mutually exclusive, as some embodiments may be combined with one or more other embodiments to form new embodiments.

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the various claimed inventions. Moreover, some statements may apply to some inventive features but not to others. Those skilled in the art and informed by the teachings herein will realize that the invention is also applicable to various other technical areas or embodiments.

Various deficiencies in the prior art are addressed by systems, methods, architectures, mechanisms, and apparatus for optical, radio frequency (RF), and/or acoustic data transmission by dividing each of one or more sequences of channel coded bits d into N blocks thereof, which are respectively spatially modulated (SM) and mapped to constellations to provide thereby respective symbol streams, which are modulated in accordance with orthogonal signal division multiplexing (OSDM) to provide respective SM-OSDM signals, which are transmitted via optical source, RF antennae, acoustic transducers, and the like during respective timeslots such that a receiver associated with a plurality of receiving devices may reconstruct the bitstream used to form the one or more sequences of channel coded bits d.

Various embodiments provide systems, methods, architectures, mechanisms and apparatus for improving communications, such as Underwater Acoustic Communications (UAC), at the physical layer (PHY).

Various embodiments are configured to implement a novel transmission scheme denoted herein as Spatial Modulation-based (SM) Orthogonal Signal Division Multiplexing (OSDM) or SM-OSDM, which when applied to optical, radio frequency (RF), and/or acoustic communications improves spectral efficiency, keeps Bit Error Rate (BER) low, and reduced interference between data streams as compared to other transmission schemes. The inventors have determined that the novel SM-OSDM system OSDM offers higher spectral efficiency than Single-Input Single-Output (SISO)-OSDM, and lower BER than Multiple-Input Multiple-Output (MIMO)-OSDM.

In Spatial Modulation (SM), a block of information bits is mapped to a source-coded symbol at a certain transmit antenna, and only this antenna is active at a given time slot, at which time slot the other antennas do not transmit symbols. Discussed below are the transceiver structure of the SM-OSDM, the modulation/demodulation process, the equations of modulator/demodulator (derived), and so on. The inventors performed a physical-layer evaluation of the SM-OSDM system based on MATLAB simulations in a realistic underwater acoustic channel with different water wave speeds (the moving speeds of the propagation medium) and varying Signal-to-Noise Ratio (SNR) values. The BER and spectral efficiency of the proposed SM-OSDM were evaluated and compared with ordinary Single-Input Single-Output (SISO)-OSDM and MIMO-OSDM in different scenarios. The simulation results show that the SM-OSDM achieves a higher spectral efficiency than SISO-OSDM and a lower BER than MIMO-OSDM with multipath and Doppler effects.

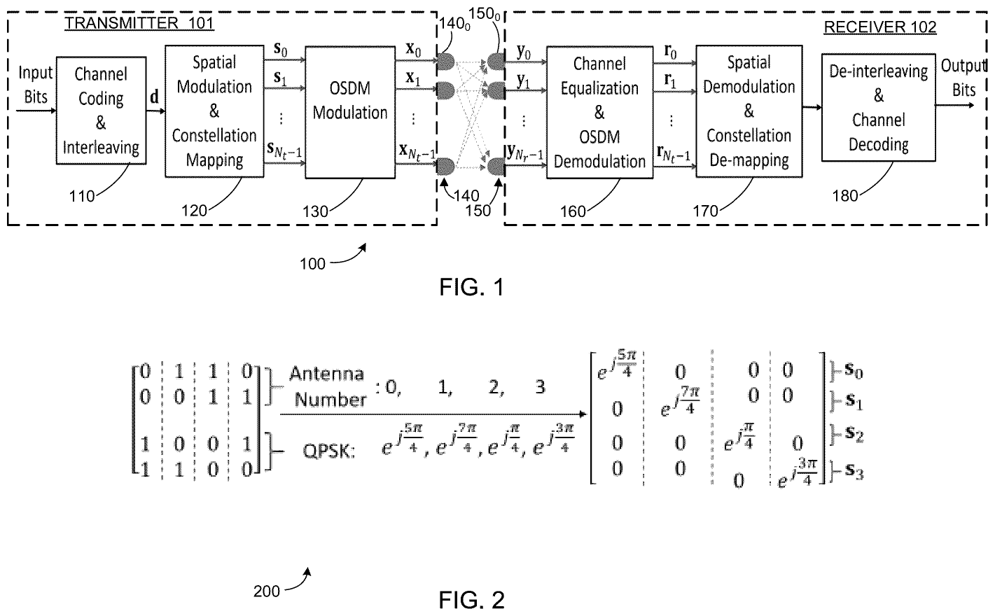

FIG. 1 depicts a high-level block diagram of a communications system according to various embodiments. Specifically, FIG. 1 depicts a system 100 comprising a transmitter 101 including various transmitter components (110-140) and a receiver 102 including various receiver components (150-180) configured to implement a novel transmission scheme denoted herein as Spatial Modulation-based (SM) Orthogonal Signal Division Multiplexing (OSDM) or SM-OSDM. System 100 provides optical, RF, and/or acoustic communications in a manner improving spectral efficiency while keeping Bit Error Rate (BER) low and reducing interference between data streams. Multiple transmitting devices (e.g., optical communications sources, RF antennae, acoustic transducers and the like) 140 are utilized by the transmitter 101, but only one transmitting device 140 is active in each time slot.

Referring to FIG. 1, at the transmitter 101 an input bit sequence is received and processed in accordance with channel coding and interleaving 110 (e.g., forward error control coding (FECC) and the like) to provide corresponding sequences of channel coded bits d, wherein each sequence of channel coded bits d is subjected to spatial modulation and constellation mapping 120 to generate a plurality (N) of different symbol streams s₀ through S_{N}_{ₜ}₋₁, each of which is subjected to respective OSDM modulation 130 to provide corresponding SM-OSDM signals X₀ through X_{N}_{ₜ}₋₁ for transmission via respective optical or RF or acoustic transmitting devices 140. In the case of underwater/undersea transmission, then via respective acoustic output devices (e.g., transducers) 1400 through 140_{N}_{ₜ}₋₁. Various embodiments contemplate that each of the transmitting devices 140 actively transmits only during a respective transmission slot.

In the transmitter 101, a channel coding and interleaving module 110 according to an embodiment may process the input bitstream or bit sequence in accordance with various channel coding techniques, such as forward error control coding (FECC), convolutional coding, turbo coding, and low-density parity check (LDPC) coding.

In the transmitter 101, the spatial modulation and constellation mapping module 120 according to an embodiment may process the channel coded bits d in accordance with various techniques, such as M-ary Phase Shift Keying (PSK), M-ary Quadrature Amplitude Modulation (QAM), and M-ary Frequency Shift Keying (FSK).

Referring to FIG. 1, at the receiver 102 each of a plurality of receiving devices (e.g., optical communications receivers, RF antennae, hydrophones and the like) 1500 through 150_{N}_{ₜ}₋₁, though more or fewer may be used, receives some or all of the transmission signals of the transmitting devices 1400 through 140_{N}_{ₜ}₋₁ and provides corresponding received signals Y₀ through Y_{N}_{ₜ}₋₁ though more or fewer received signals may be provided depending upon the number of receiving devices such as hydrophones used. The various channels are estimated by, illustratively, analyzing pilot sequences. After channel equalization and OSDM demodulation 160, a plurality of channel equalized received signals r₀ through r_{N}_{ₜ}₋₁ are subjected to spatial demodulation and constellation de-mapping 170 to retrieve therefrom a bitstream comprising one or more sequences of channel coded bits d, which bitstream is subjected to de-interleaving and channel decoding 180 to obtain therefrom an output bit sequence or bitstream representing the input bit sequence or bitstream initially processed by the transmitter 101.

In the receiver 102, a spatial demodulation and constellation de-mapping module 170 according to an embodiment processes received channel equalized signals r₀ through r_{N}_{ₜ}₋₁ in accordance with the technique(s) used by the spatial modulation and constellation mapping module 120 of the transmitter 101.

In the receiver 102, a de-interleaving and channel decoding module 180 according to an embodiment processes received channel coded bits d in accordance with the technique(s) used by the channel coding and interleaving module 110 of the transmitter 101.

FIG. 2 graphically depicts an illustrative spatial modulation structure suitable for use with the communications system 100 of FIG. 1. The spatial modulation structure 200 of FIG. 2 contemplates an exemplary transmitter 101 using Quadrature Phase Shift Keying (QPSK) and four transmitting devices 140 and Gray code applied (j=\sqrt{−1}). Other and different spatial modulation structures may be used, such as quadrature spatial modulation, improved spatial modulation, and generalized spatial modulation.

The operations of SM-OSDM transmitter 101 and receiver 102 components/functions configured to implement Spatial Modulation-based (SM) Orthogonal Signal Division Multiplexing (OSDM) or SM-OSDM will now be discussed in more detail.

Transmitter example: Given a sequence of channel coded bits d, assume the length of d is M_{d}. The number of transducers at the transmitter is Nₜ. The source coding scheme is M-ary Phase Shift Keying (PSK). In SM, first, the coded bits d is divided into N blocks, each block containing K bits, M_{d}=NK, K=log₂Nₜ+log₂M.

Referring to FIG. 2, 16 bits are divided into 4 blocks, each block containing 4 bits. The number of transducers is Nₜ=4 and, illustratively, Quadrature PSK (QPSK, M=4) is applied. Therefore, in each block, the first log₂Nₜ=2 bits decide which transducers is active, and the last log₂M=2 bits are modulated into QPSK symbol.

It is noted that while the example described herein is directed to a transmitter 101 configured to drive four transmitting devices (i.e., 140₁ through 140₄), more or fewer transmitting devices 140 may be used (i.e., N may be greater than 4 or less than 4). It is further noted that while Quadrature PSK (QPSK, M=4) is used for channel coding such that the number of bits per symbol is 4, other types of M-ary channel coding may be used such that the number of bits per symbol is more than 4 or fewer than 4 (e.g., M may equal 2, 4, 8, 16, and so on).

In the example described herein, the channel coding and interleaving module 110 receives input bits such as from an input bitstream and responsively provides sequences of channel coded bits d, wherein each sequence of channel coded bits d comprises, illustratively, 16 bits (i.e., M_{d}=16) divided in to four blocks (i.e., N=4) of four bits per block (i.e., k=4).

Let sₙ_{ₜ} represents the SM-modulated signal at each of the transmitting devices 140, nₜ=0,1, . . . ,Nₜ−1,

$${s}_{{n}_{t}} = [ \begin{matrix}{s}_{{n}_{t} , 0} & {s}_{{n}_{t} , 1} & … & {s}_{{n}_{t} , N - 1}\end{matrix} ] . \qquad ( 1 )$$

To modulate each SM signal with OSDM, sₙ_{ₜ} is divided to P blocks. Each block mₙ_{ₜ}_{,p} has a length of Q, p=0,1, . . . , P−1, N=PQ,

$${s}_{{n}_{t}} = [ \begin{matrix}{m}_{{n}_{t} , 0} & {m}_{{n}_{t} , 1} & … & {m}_{{n}_{t} , P - 1}\end{matrix} ] . \qquad ( 2 )$$

To estimate the channel, a high-autocorrelation common pilot sequence s^{p} is created with a length of Q, shared by both the transmitter 101 and the receiver. The pilot sequence is a zero-correlation zone sequence with high auto-correlation and low cross-correlation, such as Zadoff-Chu sequence, gold sequence, Kasami sequence, and complementary sequence. For example, the elements in s^{p} can be expressed by,

$${s}^{p} [ q ] = exp ( \frac{2 π j {q}^{2}}{2 Q} ) , j = \sqrt{- 1} , q = 0 , 1 , … , Q - 1. \qquad ( 3 )$$

Based on a common pilot sequence, the pilot sequence for each transmitting device 140 is given by,

$${s}_{{n}_{t}}^{p} = {{s}^{p} ( {Z}_{Q} )}^{{n}_{t} \hat{Q}} , \hat{Q} = ⌊ Q / {N}_{t} ⌋ , \qquad ( 4 )$$

where “└·┘” denotes the nearest integer in the direction of negative infinity.

Z_{Q} is the cyclic shift matrix of size Q×Q, i.e.,

$${Z}_{Q} = [ \begin{matrix}0 & 1 & 0 & … & 0 \\ 0 & 0 & 1 & … & 0 \\ ⋮ & ⋮ & ⋮ & ⋱ & 0 \\ 0 & 0 & 0 & … & 1 \\ 1 & 0 & 0 & … & 0\end{matrix} ] . \qquad ( 5 )$$

After adding the pilot sequences in front of each SM signal, the symbol vector Cₙ_{ₜ} with the length of JQ is created, J=P+1,

$${c}_{{n}_{t}} = [ \begin{matrix}{s}_{{n}_{t}}^{p} & {m}_{{n}_{t} , 0} & {m}_{{n}_{t} , 1} & … & {m}_{{n}_{t} , P - 1}\end{matrix} ] . \qquad ( 6 )$$

In various embodiments, the pilot sequences are always included within the signal transmitted by a transmitting device during the time slot associated with the transmitting device, even if there is no SM signal to be transmitted (e.g., no channel coded data to be spatially modulated and mapped). That is, inactive transducers in each time slot still OSDM modulate and transmit pilot sequences to support channel estimation, the identification of the active transmitting device(s) 140 at the receiver 102, and so on.

Based on OSDM modulation, the transmitted signal at each transmitting device 140 is,

$${x}_{{n}_{t}} = {c}_{{n}_{t}} ( {F}_{J} ⊗ {I}_{Q} ) , \qquad ( 7 )$$

where “⊗” denotes the Kronecker product, I_{Q} is the identity matrix of size
Q×Q, Fⱼ is the Inverse Discrete Fourier Transform (IDFT) [19] matrix of size J×J,

$${F}_{J} = \frac{1}{\sqrt{J}} [ \begin{matrix}{W}_{J}^{0} & {W}_{J}^{0} & … & {W}_{J}^{0} \\ {W}_{J}^{0} & {W}_{J}^{1} & … & {W}_{J}^{J - 1} \\ ⋮ & ⋮ & ⋱ & ⋮ \\ {W}_{J}^{0} & {W}_{J}^{J - 1} & … & {W}_{J}^{{( J - 1 )}^{2}}\end{matrix} ] , {W}_{J}^{k} = exp ( \frac{2 π j k}{J} ) , j = \sqrt{- 1} . \qquad ( 8 )$$

In this way, the pilot and data sequences are arranged on a rectangular lattice in the time-frequency domain and do not interfere with each other.

Receiver example: Assume there are Nᵣ receiving devices at the receiver, Nᵣ≥Nₜ. The channel response at the link (nₜ, nᵣ) is,

$${h}^{( {n}_{t} , {n}_{r} )} = [ \begin{matrix}{h}_{0}^{( {n}_{t} , {n}_{r} )} & {h}_{1}^{( {n}_{t} , {n}_{r} )} & …\end{matrix} ] . \qquad ( 9 )$$

The received signal at the nᵣ-th receiving device is,

$${\hat{y}}_{{n}_{r}} = {Σ}_{{n}_{t} = 0}^{{N}_{t} - 1} {x}_{{n}_{t}} * {h}^{( {n}_{t} , {n}_{r} )} + {η}_{{n}_{r}} , \qquad ( 10 )$$

where nᵣ=0,1, . . . , Nᵣ−1, “*” denotes the convolution operation, and ηₙ_{ᵣ} is the additive noise at the nᵣ-th receiving device.

To reduce the Inter-Symbol Interference (ISI), a Cyclic Prefix (CP) with a length of L is added, with L≤Q. Assume Lₜ is the maximum multipath delay in the time-discrete model. When L≥Lₜ, the channel reverberation is correctable. The CP-removed sequence yₙ_{ᵣ} can be expressed by,

$${y}_{{n}_{r}} = {Σ}_{{n}_{t} = 0}^{{N}_{t} - 1} {x}_{{n}_{t}} {H}^{( {n}_{t} , {n}_{r} )} + {η}_{{n}_{r}} , \qquad ( 11 )$$

$${H}^{( {n}_{t} , {n}_{r} )} = [ \begin{matrix}{h}_{0}^{( {n}_{t} , {n}_{r} )} & {h}_{1}^{( {n}_{t} , {n}_{r} )} & … & {h}_{JQ - 1}^{( {n}_{t} , {n}_{r} )} \\ {h}_{JQ - 1}^{( {n}_{t} , {n}_{r} )} & {h}_{0}^{( {n}_{t} , {n}_{r} )} & … & {h}_{JQ - 2}^{( {n}_{t} , {n}_{r} )} \\ ⋮ & ⋮ & ⋱ & ⋮ \\ {h}_{1}^{( {n}_{t} , {n}_{r} )} & {h}_{2}^{( {n}_{t} , {n}_{r} )} & … & {h}_{0}^{( {n}_{t} , {n}_{r} )}\end{matrix} ] .$$

To demodulate the OSDM signals, the transformed received signal vector z is created based on (7) and (11),

$$\begin{matrix}z = [ \begin{matrix}{y}_{0} & {y}_{1} … {y}_{{N}_{r}}\end{matrix} ] ( {I}_{{N}_{r}} ⊗ {F}_{J}^{H} ⊗ {I}_{Q} ) \\ = [ \begin{matrix}{c}_{0} & {c}_{1} … {c}_{{N}_{t} - 1}\end{matrix} ] {ℍ}_{c o m b} + \hat{η} \\ = [ \begin{matrix}{z}_{0} & {z}_{1} … {z}_{{N}_{r} - 1}\end{matrix} ] + \hat{η}\end{matrix} , \qquad ( 12 )$$

where └·┘^{H} denotes the conjugate matrix and \hat{η} is the transformed additive noise.

The combined channel matrix is,

$${ℍ}_{comb} = [ \begin{matrix}{ℍ}^{( 0 , 0 )} & {ℍ}^{( 0 , 1 )} & … & {ℍ}^{( 0 , {N}_{r} - 1 )} \\ {ℍ}^{( 1 , 0 )} & {ℍ}^{( 1 , 1 )} & … & {ℍ}^{( 1 , {N}_{r} - 1 )} \\ ⋮ & ⋮ & ⋱ & ⋮ \\ {ℍ}^{( {N}_{t} - 1 , 0 )} & {ℍ}^{( {N}_{t} - 1 , 1 )} & … & {ℍ}^{( {N}_{t} - 1 , {N}_{r} - 1 )}\end{matrix} ] . \qquad ( 13 )$$

[symbol] ⁽ⁿ^{ₜ}^{,n}^{ᵣ₎} is the multipath delay channel matrix,

$${ℍ}^{( {n}_{t} , {n}_{r} )} = diag ( {ℍ}_{0}^{( {n}_{t} , {n}_{r} )} , {ℍ}_{1}^{( {n}_{t} , {n}_{r} )} , … , {ℍ}_{J - 1}^{( {n}_{t} , {n}_{r} )} ) , \qquad ( 14 )$$

where diag(·) represents the block diagonal matrix. The submatrix [symbol] ₖ⁽ⁿ^{ₜ}^{,n}^{ᵣ₎} is defined by,

$${ℍ}_{k}^{( {n}_{t} , {n}_{r} )} = [ \begin{matrix}{h}_{0}^{( {n}_{t} , {n}_{r} )} & {h}_{1}^{( {n}_{t} , {n}_{r} )} & … & {h}_{Q - 1}^{( {n}_{t} , {n}_{r} )} \\ {W}_{J}^{- k} {h}_{Q - 1}^{( {n}_{t} , {n}_{r} )} & {h}_{0}^{( {n}_{t} , {n}_{r} )} & … & {h}_{Q - 2}^{( {n}_{t} , {n}_{r} )} \\ ⋮ & ⋮ & ⋱ & ⋮ \\ {W}_{J}^{- k} {h}_{1}^{( {n}_{t} , {n}_{r} )} & {W}_{J}^{- k} {h}_{2}^{( {n}_{t} , {n}_{r} )} & … & {h}_{0}^{( {n}_{t} , {n}_{r} )}\end{matrix} ] . \qquad ( 15 )$$

The elements in (12) are calculated by,

$$\begin{matrix}{z}_{{n}_{r}} = {Σ}_{{n}_{t} = 0}^{{N}_{t} - 1} {c}_{{n}_{t}} {ℍ}^{( {n}_{t} , {n}_{r} )} \\ = {Σ}_{{n}_{t} = 0}^{{N}_{t} - 1} [ \begin{matrix}\begin{matrix}{s}_{{n}_{t}}^{p} & {m}_{{n}_{t} , 0}\end{matrix} & {m}_{{n}_{t} , 1} … {m}_{{n}_{t} , P - 1}\end{matrix} ] {ℍ}^{( {n}_{t} , {n}_{r} )} \\ = [ \begin{matrix}\begin{matrix}{z}_{{n}_{r}}^{p} & {z}_{{n}_{r} , 0}\end{matrix} & {z}_{{n}_{r} , 1} … {z}_{{n}_{r} , P - 1}\end{matrix} ] , {n}_{r} = 0 , 1 , … , {N}_{r} - 1\end{matrix} . \qquad ( 16 )$$

Therefore, the received pilot sequence at the nᵣ-th receiver 102 is,

$${z}_{{n}_{r}}^{p} = {Σ}_{{n}_{t} = 0}^{{N}_{t} - 1} {s}_{{n}_{t}}^{p} {ℍ}_{0}^{( {n}_{t} , {n}_{r} )} = {s}^{p} {Σ}_{{n}_{t} = 0}^{{N}_{t} - 1} {( {Z}_{Q} )}^{{n}_{t} \hat{Q}} {ℍ}_{0}^{( {n}_{t} , {n}_{r} )} . \qquad ( 17 )$$

Now, if we assume \hat{Q}≥Lₜ,

$${h}^{( {n}_{t} , {n}_{r} )} = [ \begin{matrix}{h}_{0}^{( {n}_{t} , {n}_{r} )} & {h}_{1}^{( {n}_{t} , {n}_{r} )} … {h}_{\hat{Q}}^{( {n}_{t} , {n}_{r} )} & {0}_{1 \times ( Q - \hat{Q} )}\end{matrix} ] , \qquad ( 18 )$$

$${h}^{( {n}_{t} , {n}_{r} )} = [ \begin{matrix}{h}_{0}^{( {n}_{t} , {n}_{r} )} & {h}_{1}^{( {n}_{t} , {n}_{r} )} … {h}_{\hat{Q}}^{( {n}_{t} , {n}_{r} )}\end{matrix} ] , \qquad ( 19 )$$

where 0_{1×(Q-\hat{Q})} is the zero matrix of size 1×(Q-\hat{Q}).

Let [symbol] ₀ⁿ^{ᵣ}=Σₙ_{ₜ}₌₀^{N}^{ₜ}⁻¹(Z_{Q})ⁿ^{ₜ}^{\hat{Q}} [symbol] ₀⁽ⁿ^{ₜ}^{,n}^{ᵣ}⁾, which can be calculated by [symbol] ₀ⁿ^{ᵣ}=(s^{p})^{H}Zₙ_{ᵣ}^{p}/∥s^{p}∥² according to (17). Then the channel response can be estimated as,

$${ℍ}_{0}^{{n}_{r}} {I}_{1 \times Q} = [ \begin{matrix}{h}^{( 0 , {n}_{r} )} & {h}^{( 1 , {n}_{r} )} … {h}^{( {n}_{t} - 1 , {n}_{r} )} & {0}_{1 \times ( Q - \hat{Q} )}\end{matrix} ] , \qquad ( 20 )$$

$$where {I}_{1 \times Q} = [ \begin{matrix}1 & 0 & 0 … 0\end{matrix} ] .$$

Given the estimated combined channel matrix [symbol] _{comb}, the channel equalized signals are calculated by,

$$[ \begin{matrix}{r}_{0} & {r}_{1} … {r}_{{N}_{t} - 1}\end{matrix} ] = z {{\hat{ℍ}}_{c o m b}^{H} ( {\hat{ℍ}}_{c o m b} {\hat{ℍ}}_{c o m b}^{H} )}^{- 1} , \qquad ( 21 )$$

where └·┘⁻¹ denotes the inverse matrix.

$${ℍ}_{comb} = [ \begin{matrix}{\hat{ℍ}}^{( 0 , 0 )} & {\hat{ℍ}}^{( 0 , 1 )} & … & {\hat{ℍ}}^{( 0 , {N}_{r} - 1 )} \\ {\hat{ℍ}}^{( 1 , 0 )} & {\hat{ℍ}}^{( 1 , 1 )} & … & {\hat{ℍ}}^{( 1 , {N}_{r} - 1 )} \\ ⋮ & ⋮ & ⋱ & ⋮ \\ {\hat{ℍ}}^{( {N}_{t} - 1 , 0 )} & {\hat{ℍ}}^{( {N}_{t} - 1 , 1 )} & … & {\hat{ℍ}}^{( {N}_{t} - 1 , {N}_{r} - 1 )}\end{matrix} ] , \qquad ( 22 )$$

$${\hat{ℍ}}^{( {n}_{t} , {n}_{r} )} = diag ( {ℍ}_{1}^{( {n}_{t} , {n}_{r} )} , {ℍ}_{2}^{( {n}_{t} , {n}_{r} )} , … , {ℍ}_{P}^{( {n}_{t} , {n}_{r} )} ) . \qquad ( 23 )$$

Spatial demodulation is performed by analyzing the maximum power of symbols at the different receiving devices in each time slot, while the constellation de-mapping is done based on the minimal Euclidean distance. The demodulated bits are de-interleaved and channel decoded to obtain the output bits.

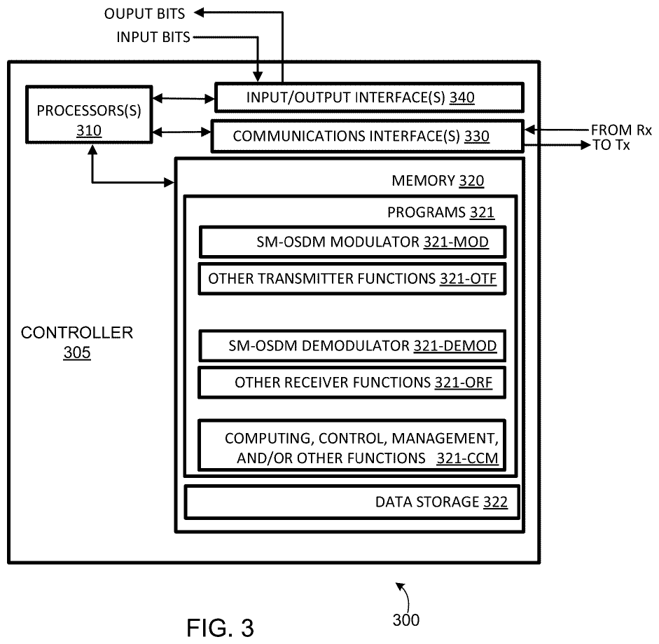

FIG. 3 depicts a high-level block diagram of a controller suitable for use in various embodiments, such as to implement a transmitter, receiver, transceiver, system or component thereof in accordance with the various embodiments. The controller 305 depicted in FIG. 3 comprises a computing device that may be configured to perform various computing, processing, control, and/or other functions such as described herein with respect to the figures and equations. For example, the controller 305 may perform various transmitter and/or receiver functions such as described herein with respect to the various figures and equations.

As depicted in FIG. 3, the controller 305 includes one or more processors 310, a memory 320, a communications interface 330, and input-output (I/O) interface(s) 340. The processor(s) 310 are coupled to each of memory 320, communication interfaces 330, and I/O interfaces 340.

The processor(s) 310 are configured for controlling the operation of controller 305, including operations supporting the methodologies described herein with respect to the various embodiments. Similarly, the memory 320 is configured for storing information suitable for use by the processor(s) 310. Specifically, memory 320 may store programs 321, data 322 and so on. Within the context of the various embodiments, the programs 321 and data 322 may vary depending upon the specific functions implemented by the controller 305, such as transmitter functions 101, receiver functions 102, or transmitter and receiver (i.e., transceiver 101/102) functions.

For example, as depicted in FIG. 3, the programs portion 321 of memory 320 includes a SM-OSDM modulator 321-MOD and other transmitter functions 321-OTF suitable for implementing transmitter functions 101 in accordance with various embodiments, as well as a SM-OSDM demodulator 321-DEMOD and other receiver functions 321-ORF suitable for implementing receiver functions 102 in accordance with various embodiments. Further, the programs portion 321 of memory 320 includes a computing, control, management, and/or other functions module 321-CCM suitable for implementing various computing, control, management, data processing, communications, and/or other functions suitable for use within the various embodiments, such as the various other primary or supporting functions discussed in this specification.

Generally speaking, the memory 320 may store any information suitable for use by the controller 305 in implementing one or more of the various methodologies or mechanisms described herein. It will be noted that while various functions are associated with specific programs or databases, there is no requirement that such functions be associated in a specific manner. Thus, any implementations achieving the functions of the various embodiments may be used.

The communications interfaces 330 may include one or more services signaling interfaces adapted to facilitate the transfer of information, files, data, messages, requests and the like between various entities in accordance with the embodiments discussed herein.

The I/O interface 340 and/or communications interfaces 330 may be coupled to receive input bitstreams for SM-OSDM modulation and transmission and/or to provide output bitstreams resulting from SM-OSDM demodulation. Various input/output devices may be used for such purposes.

Various embodiments are implemented using a controller 305 comprising processing resources (e.g., one or more servers, processors and/or virtualized processing elements or compute resources) and non-transitory memory resources (e.g., one or more storage devices, memories and/or virtualized memory elements or storage resources), wherein the processing resources are configured to execute software instructions stored in the non-transitory memory resources to implement thereby the various methods and processes described herein. As such, the various functions depicted and described herein may be implemented at the elements or portions thereof as hardware or a combination of software and hardware, such as by using a general-purpose computer, one or more application specific integrated circuits (ASIC), or any other hardware equivalents or combinations thereof. In various embodiments, computer instructions associated with a function of an element or portion thereof are loaded into a respective memory and executed by a respective processor to implement the respective functions as discussed herein. Thus, various functions, elements and/or modules described herein, or portions thereof, may be implemented as a computer program product wherein computer instructions, when processed by a computing device, adapt the operation of the computing device such that the methods or techniques described herein are invoked or otherwise provided. Instructions for invoking the inventive methods may be stored in tangible and non-transitory computer readable medium such as fixed or removable media or memory or stored within a memory within a computing device operating according to the instructions.

It is contemplated that some of the steps discussed herein as software methods may be implemented within special-purpose hardware, for example, as circuitry that cooperates with the processor to perform various method steps.

Although primarily depicted and described as having specific types and arrangements of components, it will be appreciated that any other suitable types and/or arrangements of components may be used for controller 305.

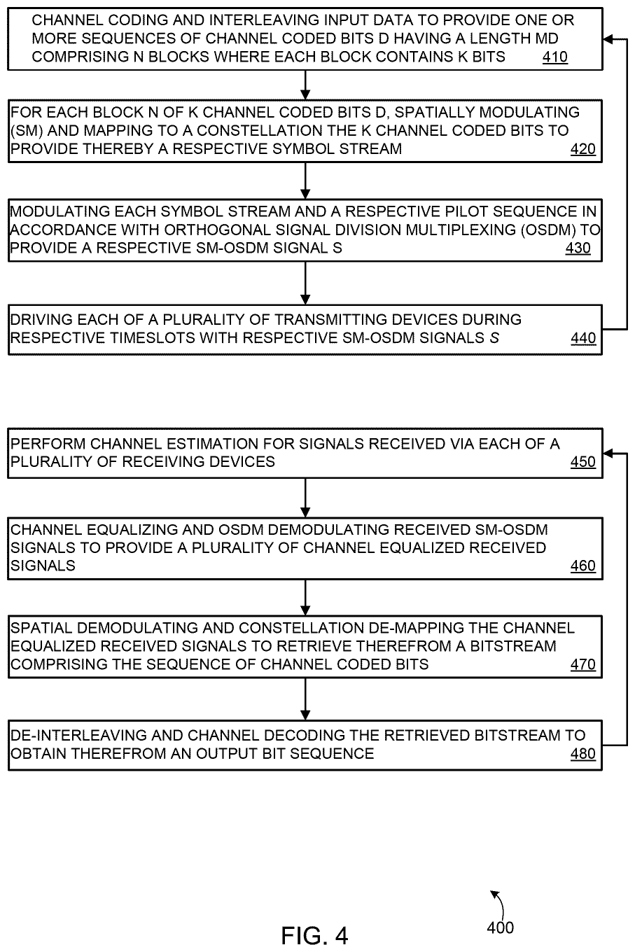

FIG. 4 depicts a flow diagram of a method according to an embodiment. Specifically, FIG. 4 contemplates a method 400 suitable for processing received input bitstreams for SM-OSDM modulation and transmission at a transmitter, and for demodulating a received SM-OSDM modulated signals.

Steps 410-440 represent transmitter functions that are repeated as necessary to encode and transmit data, such as for each sequence of channel coded bits d of length M_{d} to be transmitted.

At step 410, an input data bitstream or bit sequence is subjected to channel coding and interleaving 110 (e.g., FECC) to provide thereby one or more sequences of channel coded bits d of length M_{d} comprising N blocks wherein each of the N blocks contains K bits. In an example, each of the one or more sequences of channel coded bits d comprises 16 bits (i.e., M_{d}=16), which is divided into four blocks (i.e., N=4) of four bits per block (i.e., k=4).

At step 420, for each block N of k bits of a channel coded bit sequence d, the k channel coded bits d are subjected to spatial modulation (SM) and constellation mapping 120 to provide thereby a plurality of different symbol streams s.

At step 430, each symbol stream s (along with its corresponding or respective pilot sequence) is modulated in accordance with orthogonal signal division multiplexing (OSDM) to provide a respective SM-OSDM signal suitable for use for transmission via a respective transmitting device during a respective transmission timeslot, such as a submerged acoustic output device in the case of undersea communications.

At step 440, each of a plurality (e.g., N) of transmitting devices 140 is driven with a respective symbol stream s during a respective timeslot for acoustic transmission. In the example, where N=4 and there are four transmitting devices 140 used, each of the transmitting devices 140 receives a respective symbol stream s for acoustic transmission during a respective timeslot (e.g., a respective one of N=4 timeslots).

Steps 450-480 represent receive functions that are repeated as necessary to receive and decode the data, such as for each sequence of channel coded bits d of length M_{d} received via receiving devices, such as submerged hydrophones in the case of undersea communications.

At step 450, channel estimation is performed for signals received from each of a plurality of receiving devices (e.g., from a plurality of receiving devices 150) such a by using the pilot sequence information as described above. In an example, the number of receiving devices 150 is greater than or equal to the number of transmitting devices 140. While various forms of channel estimation may be used, the embodiments discussed herein a pilot sequence is included with each time-slotted transmission (with or without data as noted above) such that channel estimation and channel equalization to remove distortion and/or noise at the receivers may be performed as described herein.

At step 460, channel equalizing and OSDM demodulating of received SM-OSDM signals provides a plurality of channel equalized received signals.

At step 470, the channel equalized received signals are subjected to spatial demodulating and constellation de-mapping retrieve therefrom a bitstream comprising the sequence of channel coded bits d.

At step 480, the sequence of channel coded bits d is subjected to de-interleaving and channel decoding to obtain therefrom an output bit sequence representative of the input data.

### Performance Evaluation

A physical-layer simulator of a SM-OSDM system will now be described in detail, along with relevant parameters. The turbo coding with the coding rate of R_{ch}=⅓ is utilized to enhance the system reliability. The coded bits are modulated by QPSK in SM. The simulation channels are assumed to be Rayleigh fading with multipath delay and Doppler effects. The symbol rate is Rₛ=6 kBd. The frequency band is 8 kHz-14 kHz and the bandwidth is B_{w}=6 kHz. The sampling frequency is 9.6 kHz. The carrier frequency is 11 kHz. The transmitter 101 and the receiver 102 are assumed to be static, while the water wave speed is assumed to be 0-0.3 m/s. Furthermore, J=4, P=64, and L=16. The maximum multipath delay is 1.67 ms.

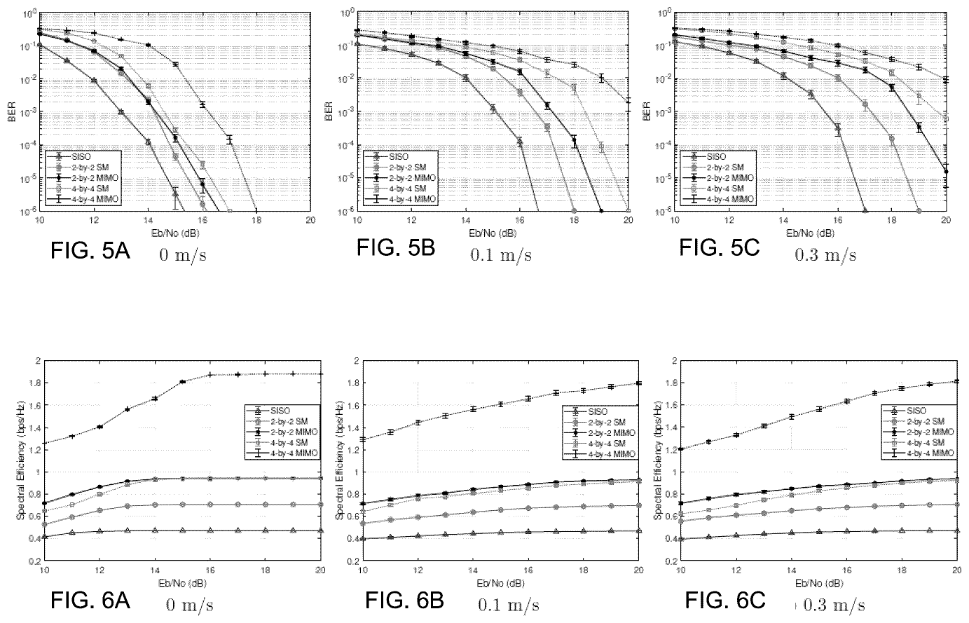

FIGS. 5A-5C graphically illustrate Bit Error Rate (BER) as a function of normalized SNR (Eb/No) for different modulation schemes and different water wave speeds of, respectively is 0 m/s, 0.1 m/s, and 0.3 m/s. The 95% confidence intervals are depicted. It can be seen that the BER performance of 4-by-4 SM-OSDM is better than 4-by-4 MIMO-OSDM, since only one transmitting device 140 is active to transmit interest information in each time slot for SM-OSDM, and there is less interference between different streams. Nonetheless, the BER of SM-OSDM is worse than SM-SISO, because inactive transducers in each time slot still transmit pilot sequences for channel estimation and the identification of the active transmitting device 140 at the receiver 102, which results in interference. It can also be seen that the BER of the 4-by-4 SM-OSDM is higher than for the 2-by-2 SM-OSDM, because the 4-by-4 system suffers from higher interference between transducers. As shown in FIG. 5A, where the water wave speed is 0 m/s, the BER of the 2-by-2 SM-OSDM is close to that of the 2-by-2 MIMO-OSDM, but in FIG. 5B-5C it is obvious that the BER of the 2-by-2 SM-OSDM is better than that of the 2-by-2 MIMO-OSDM, since the SM-OSDM provides higher robustness against the Doppler effects.

FIG. 6A-6C graphically illustrate spectral efficiency as a function of Eb/No for different modulation schemes and different water wave speeds of, respectively is 0 m/s, 0.1 m/s, and 0.3 m/s. The 95% confidence intervals are depicted. The 95% confidence intervals are less than 10-2 and hence are not visible in FIGS. 4A-4C. The spectral efficiency is calculated by

$$\frac{{R}_{s} N K {R}_{c h} {R}_{p}}{{B}_{w} ( N + L )} ( 1 - B E R ) , {R}_{p} = 1 - \frac{1}{4}$$

for one pilot in every 4 symbols. It can be seen that the 4-by-4 MIMO-OSDM provides the highest spectral efficiency, but its efficiency decreases dramatically when the SNR is lower than 16 dB. The 2-by-2 MIMO-OSDM is close to the 4-by-4 SM-OSDM and is better when the SNR is low, and the Doppler is high. Therefore, it can be concluded that there is a trade-off between BER and spectral efficiency; namely, when a low BER is needed, the 2-by-2 SM-OSDM should be used whereas when achieving a high spectral efficiency is more important, the 4-by-4 MIMO-OSDM should be adopted.

The various embodiments described herein are directed to a novel physical-layer transmission scheme for underwater/undersea ACOMMS, denoted as SM-OSDM, which may also be used for radio frequency (RF) or optical transmission in non-underwater environments. A series of simulations to evaluate performance have been conducted, and the results show that the SM-OSDM achieved a lower BER than MIMO-OSDM with the same deployment of transducers and hydrophones (or other transmitting/receiving devices), especially in high Doppler channels. The SM-OSDM also offered a higher spectral efficiency than SISO-OSDM. The trade-off between BER and spectral efficiency was discussed as well.

Although various embodiments which incorporate the teachings of the present invention have been shown and described in detail herein, those skilled in the art can readily devise many other varied embodiments that still incorporate these teachings. Thus, while the foregoing is directed to various embodiments of the present invention, other and further embodiments of the invention may be devised without departing from the basic scope thereof.

What is claimed is:

1. A method of communication, comprising:
channel coding and interleaving input data to provide one or more sequences of channel coded bits d;
spatially modulating (SM) and mapping to a constellation each sequence of channel coded bits d to provide a respective plurality of symbol streams;
modulating each symbol stream and its respective pilot sequence in accordance with orthogonal signal division multiplexing (OSDM) to provide a respective SM-OSDM signal; and
transmitting each SM-OSDM signal via a respective transmitting device during a respective time slot.

2. The communication method of claim 1, wherein the communication method comprises an undersea communication method, and each respective transmitting device comprise a submerged acoustic output device.

3. The communication method of claim 1, wherein the communication method comprises a radio frequency (RF) communication method, and each respective transmitting device comprises a RF antenna.

4. The method of claim 1, wherein spatially modulating (SM) and mapping to a constellation the channel coded bits d is performed in accordance with M-ary Phase Shift Keying (PSK).

5. The method of claim 4, wherein said SM and mapping to a constellation further comprises applying a Gray code to align thereby each SM-OSDM signal with a respective acoustic output device timeslot.

6. The method of claim 1, wherein spatially modulating (SM) and mapping to a constellation the channel coded bits d is performed in accordance with M-ary Quadrature Amplitude Modulation (QAM) or M-ary Frequency Shift Keying (FSK).

7. The method of claim 1, wherein spatially modulating (SM) and mapping to a constellation the channel coded bits d is performed in accordance with Quadrature Phase Shift Keying (QPSK) and a Gray code applied (j=\sqrt{−1}).

8. The method of claim 2, wherein each of N submerged acoustic output devices transmits a respective SM-OSDM signal during a respective timeslot, wherein N is an integer greater than one.

9. The method of claim 8, wherein each sequence of channel coded bits d comprises M_{d} bits divided into N blocks of K bits.

10. The method of claim 9, wherein M_{d}=16, N=4, and K=4.

11. The method of claim 1, further comprising:
receiving, via each of a second plurality of acoustic input devices, some or all of the transmitted SM-OSDM signals;
channel estimating received SM-OSDM signals using pilot sequences included therein;
channel equalizing and OSDM demodulating received SM-OSDM signals to provide a plurality of channel equalized received signals;
spatial demodulating and constellation de-mapping the channel equalized received signals to retrieve therefrom a bitstream comprising the sequence of channel coded bits d; and
de-interleaving and channel decoding the retrieved bitstream to obtain therefrom an output bit sequence.

12. The method of claim 11, wherein spatial demodulation is performed by analyzing the maximum power of symbols at the different receiving devices in each time slot, and constellation de-mapping is based on minimal Euclidean distance.

13. The method of claim 11, wherein pilot sequences s^{p} have a length Q and are expressed as:
$${s}^{p} [ q ] = exp ( \frac{2 π j {q}^{2}}{2 Q} ) , j = \sqrt{- 1} , q = 0 , 1 , … , Q - 1.$$

14. The method of claim 12, wherein the channel equalized signals are calculated by,
[r₀ r₁ . . . r_{N}_{_{t−1}}]=z [symbol] _{comb}^{H}( [symbol] _{comb} [symbol] _{comb}^{H})⁻¹, where [·]⁻¹ denotes the inverse matrix, and where:
$${ℍ}_{comb} = [ \begin{matrix}{\hat{ℍ}}^{( 0 , 0 )} & {\hat{ℍ}}^{( 0 , 1 )} & … & {\hat{ℍ}}^{( 0 , {N}_{r} - 1 )} \\ {\hat{ℍ}}^{( 1 , 0 )} & {\hat{ℍ}}^{( 1 , 1 )} & … & {\hat{ℍ}}^{( 1 , {N}_{r} - 1 )} \\ ⋮ & ⋮ & ⋱ & ⋮ \\ {\hat{ℍ}}^{( {N}_{t} - 1 , 0 )} & {\hat{ℍ}}^{( {N}_{t} - 1 , 1 )} & … & {\hat{ℍ}}^{( {N}_{t} - 1 , {N}_{r} - 1 )}\end{matrix} ] ,$$
$$and$$
$${\hat{ℍ}}^{( {n}_{t} , {n}_{r} )} = diag ( {ℍ}_{1}^{( {n}_{t} , {n}_{r} )} , {ℍ}_{2}^{( {n}_{t} , {n}_{r} )} , … , {ℍ}_{P}^{( {n}_{t} , {n}_{r} )} ) .$$

15. A communications apparatus, comprising:
a spatial modulation (SM) orthogonal signal division multiplexing (OSDM) transmitter configured for generating a plurality of SM-OSDM signals for transmission, the SM-OSDM transmitter comprising:
a channel coding and interleaving module for channel coding and interleaving input data to provide one or more sequences of channel coded bits d;
a spatial modulator (SM) and mapping module, for spatially modulating (SM) and mapping to a constellation each sequence of channel coded bits d to provide a respective plurality of symbol streams; and
an OSDM modulator, for modulating each symbol stream and its respective pilot sequence in accordance with orthogonal signal division multiplexing (OSDM) to provide respective SM-OSDM signals suitable for transmission via respective transmitting devices during respective time slots.

16. The communication apparatus of claim 15, wherein the communication apparatus comprises an undersea communication apparatus, and each respective transmitting device comprise a submerged acoustic output device.

17. The communication apparatus of claim 15, wherein the communication apparatus comprises a radio frequency (RF) communication apparatus, and each respective transmitting device comprises a RF antenna.

18. The communication apparatus of claim 15, wherein spatially modulating (SM) and mapping to a constellation the channel coded bits d is performed in accordance with M-ary Phase Shift Keying (PSK), M-ary Quadrature Amplitude Modulation (QAM), or M-ary Frequency Shift Keying (FSK).

19. The communication apparatus of claim 15, wherein said SM and mapping to a constellation further comprises applying a Gray code to align thereby each SM-OSDM signal with a respective acoustic output device timeslot.

20. The communications apparatus of claim 15, further comprising:
a SM-OSDM receiver configured for receiving a plurality of SM-OSDM signals and obtaining therefrom the input bit sequence, the SM-OSDM receiver comprising:
a channel equalizing and OSDM demodulating module for processing received SM-OSDM signals to provide a plurality of channel equalized received signals;
a spatial demodulating and constellation de-mapping module for spatial demodulating and constellation de-mapping the channel equalized received signals to retrieve therefrom a bitstream comprising the sequence of channel coded bits d; spatially demodulating and constellation de-mapping the channel equalized received signals to retrieve therefrom a bitstream comprising the sequence of channel coded bits d; and
a de-interleaving and channel decoding module, for de-interleaving and channel decoding the received bitstream to obtain therefrom an output bit sequence.

21. A communications system, comprising:
a spatial modulation (SM) orthogonal signal division multiplexing (OSDM) transmitter configured for generating a plurality of SM-OSDM signals for transmission, the SM-OSDM transmitter comprising:
a channel coding and interleaving module for channel coding and interleaving input data to provide one or more sequences of channel coded bits d;
a spatial modulator (SM) and mapping module, for spatially modulating (SM) and mapping to a constellation each sequence of channel coded bits d to provide a respective plurality of symbol streams; and
an OSDM modulator, for modulating each symbol stream and its respective pilot sequence in accordance with orthogonal signal division multiplexing (OSDM) to provide respective SM-OSDM signals suitable for transmission via respective transmitting devices during respective time slots; and
a SM-OSDM receiver configured for receiving a plurality of SM-OSDM signals and obtaining therefrom the input bit sequence, the SM-OSDM receiver comprising:
a channel equalizing and OSDM demodulating module for processing received SM-OSDM signals to provide a plurality of channel equalized received signals;
a spatial demodulating and constellation de-mapping module for spatial demodulating and constellation de-mapping the channel equalized received signals to retrieve therefrom a bitstream comprising the sequence of channel coded bits d; and
a de-interleaving and channel decoding module, for de-interleaving and channel decoding the received bitstream to obtain therefrom an output bit sequence.
